(19) United States
(12) Patent Application Publication
(10) Pub. No.: US 2026/0296862 A1
(43) Pub. Date: Oct. 1, 2026

(54) POWER TRACK ASSEMBLY FOR LIFT DEVICE

(71) Applicant: Oshkosh Corporation, Oshkosh, WI (US)

(72) Inventors: Davide Boroni, Verona (IT); Zeno Poltronieri, Verona (IT); Matteo Vecchini, Verona (IT)

(73) Assignee: Oshkosh Corporation, Oshkosh, WI (US)

(21) Appl. No.: 19/633,797

(22) Filed: Mar. 30, 2026

(30) Foreign Application Priority Data
Apr. 1, 2025 (IT) 102025000006915

(51) Int. Cl. B66F 11/04

(52) U.S. Cl. CPC B66F 11/046

(57) ABSTRACT

A boom assembly includes a first boom section, a second boom section slidably coupled to a first inner cavity of the first boom section, and a third boom section slidably coupled to a second inner cavity of the second boom section, a linear actuator positioned outside of the cavities and including a body and a rod, extension of the rod causing the second boom section to extend from the first boom section, a first pulley coupled to the second boom section, and a first rope coupled to the first boom section, wrapping around the first pulley, and coupled to the third boom section, extension of the second boom section configured to tension the first rope to cause the third boom section to extend from the second boom section.

### CROSS-REFERENCE TO RELATED APPLICATIONS

This application claims the benefit of and priority to Italian Patent Application No. 102025000006915, filed Apr. 1, 2025, which is incorporated by reference herein in its entirety.

### BACKGROUND

The present application relates generally to the field of lift devices. More specifically, the present application relates to a device for supporting hydraulic, pneumatic, and electrical lines extending between a chassis and an aerial work platform. Aerial work platforms are used in various applications (e.g., construction, maintenance, etc.) and support an operator in an elevated position. A telescoping boom couples the aerial work platform to a chassis of the lift machine, and a hydraulic system (e.g., hydraulic hoses, telescopic cylinders, etc.) extends the telescoping boom and aerial work platform. Controls for the hydraulic system may be located on the aerial work platform to allow an operator to position the aerial work platform from an elevated position. Hydraulic, pneumatic, and electrical lines extend between the chassis and the aerial work platform to facilitate such control.

Traditional lift devices include a carrier to support the weight of the hydraulic, pneumatic, and electrical lines that extend between the chassis and the aerial work platform. The carrier is traditionally coupled to the outside of the telescoping boom sections with support brackets. The external position of the carrier exposes the hydraulic, pneumatic, and electrical lines therein to damage (e.g., due to contact with a beam at a construction site, due to falling debris, etc.). Further, supporting the carrier with brackets at several locations along its length may expose the hydraulic, pneumatic, and electrical lines to adverse strain conditions (i.e., the weight of the lines may damage the ends, couplers, or the line itself). Other traditional lift devices include a carrier positioned partially within the boom section, but removal of such carriers for service to the lines (e.g., replace a connection, check the connection for leaks, etc.) may be difficult and require disassembly of the telescoping boom assembly. Further, these traditional designs do not support the length of the carrier, thereby exposing the lines to damage.

### SUMMARY

At least one aspect relates to a boom assembly for a lift device including a first boom section, a second boom section slidably coupled to a first inner cavity of the first boom section, and a third boom section slidably coupled to a second inner cavity of the second boom section, a linear actuator positioned outside of the first inner cavity and the second inner cavity and including a body coupled to the first boom section and a rod coupled to the second boom section, extension of the rod relative to the body configured to cause the second boom section to extend from the first boom section, and retraction of the rod relative to the body is configured to cause the second boom section to retract into the first boom section, and a first extension assembly including a first pulley coupled to the second boom section and a first rope coupled to the first boom section, wrapping around the first pulley, and coupled to the third boom section, wherein the extension of the second boom section from the first boom section is configured to tension the first rope to cause the third boom section to extend from the second boom section.

At least one other aspect relates to a boom assembly for a lift device including a base boom, an inner mid boom slidably coupled to a first inner cavity of the base boom, a middle mid boom slidably coupled to a second inner cavity of the inner mid boom, an outer mid boom slidably coupled to a third inner cavity of the middle mid boom, and a fly boom slidably coupled to a fourth inner cavity of the outer mid boom; a linear actuator positioned outside of the inner cavities and including a body coupled to the base boom and a rod coupled to the inner mid boom, extension of the rod relative to the body configured to cause the inner mid boom to extend from the base boom, and retraction of the rod relative to the body is configured to cause the inner mid boom to retract into the base boom, a first extension assembly including a first pulley coupled to the inner mid boom and a first rope coupled to the base boom, wrapping around the first pulley, and coupled to the middle mid boom, wherein the extension of the inner mid boom from the base boom is configured to tension the first rope to cause the middle mid boom to extend from the inner mid boom, and a first retraction assembly including a second pulley coupled to the inner mid boom and a second rope coupled to the base boom, wrapping around the second pulley, and coupled to the middle mid boom, wherein the retraction of the inner mid boom into the base boom is configured to tension the second rope to cause the middle mid boom to retract into the inner mid boom.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 is a schematic side view of a lift device including a boom assembly.

FIG. 2 is a perspective view of a boom assembly for a lift device illustrating a first extension assembly and a first retraction assembly, according to an exemplary embodiment.

FIG. 3 is a schematic side view of the boom assembly of FIG. 2 illustrating the first extension assembly and the first retraction assembly, according to an exemplary embodiment.

FIG. 4 is a perspective view of the boom assembly of FIG. 2 illustrating a second extension assembly and a second retraction assembly, according to an exemplary embodiment.

FIG. 5 is a schematic side view of the boom assembly of FIG. 2 illustrating the second extension assembly and the second retraction assembly, according to an exemplary embodiment.

FIG. 6 is a perspective view of the boom assembly of FIG. 2 illustrating a third extension assembly and a third retraction assembly, according to an exemplary embodiment.

FIG. 7 is a schematic side view of the boom assembly of FIG. 2 illustrating the third extension assembly and the third retraction assembly, according to an exemplary embodiment.

FIG. 8 is a cross-sectional side view of a portion of the boom assembly of FIG. 2, according to an exemplary embodiment.

FIG. 9 is a cross-sectional side view of the boom assembly of FIG. 2, according to an exemplary embodiment.

It will be recognized that the figures are schematic representations of examples for purposes of illustration. The figures are provided for the purpose of illustrating example implementations with the explicit understanding that the figures will not be used to limit the scope of the meaning of the claims. Thus, the description is not limited to the examples and/or implementations provided in the drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

A telescoping boom may be used in various lift devices, including work platform boom lifts, telehandlers, articulating boom lifts, cranes, etc. In typical telescoping booms, several hollow boom sections may nest into each other, and a linear actuator, such as a hydraulic cylinder, may be positioned inside the boom sections. Upon the actuation of the linear actuator, the smaller boom sections nested into the larger boom sections may extend outwardly from the larger boom sections to extend the length of the boom. This may allow the lift device to reach locations higher above and farther from the base of the lift device. In some cases, it may be useful to minimize the size of the boom when the boom sections are retracted and nested into each other. This may allow the lift device to fit into smaller spaces. However, reducing the length of the retracted boom typically requires reducing the length of the linear actuator and/or the boom sections, which may limit the extended length of the boom.

In the embodiments described herein, a boom is provided with a linear actuator positioned outside the boom sections rather than within them. The boom further includes a system of ropes and pulleys configured to cause the extension of the boom sections not directly connected to the linear actuator. Positioning the linear actuator outside the boom may allow for more space inside the boom for the pulley system. Booms according to the embodiments described herein may have a shorter length while retracted while having an extended length comparable to typical booms with larger retracted lengths. Positioning the linear actuator outside of the boom may also allow for a reduction in the cross sectional area of the boom, further reducing the overall size of the boom. Further, with the linear actuator outside of the boom, cables and hoses may be more easily routed through the inside of the boom.

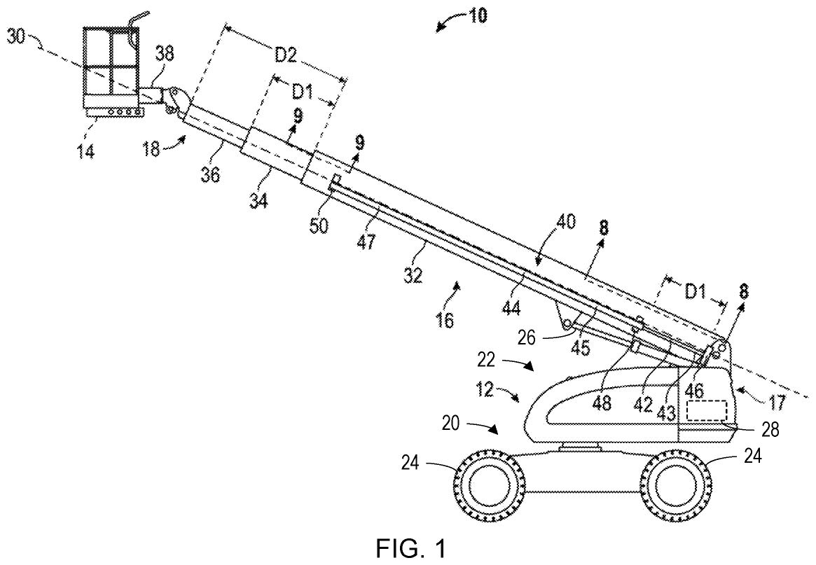

Referring now to FIG. 1, an example of a typical lift device, shown as boom lift 10, includes a chassis, shown as body 12, and a work implement, shown as platform 14. The platform 14 is coupled to the body 12 via a boom assembly, shown as boom 16. According to an exemplary embodiment, platform 14 may support one or more workers. In some examples, the platform 14 may be equipped with tools for use by a worker, including pneumatic tools (e.g., impact wrench, airbrush, nail gun, ratchet, etc.), welders, plasma cutters, and spotlights, among other alternatives. In other examples, the boom lift 10 includes a different implement coupled to the boom 16 (e.g., a saw, drill, jackhammer, lift forks, etc.) in place of or in addition to the platform 14.

The boom 16 has a first or proximal end 17 pivotally coupled to the body 12 and a second or distal end 18 coupled to the platform 14. By pivoting the boom 16 at the first end 17, the platform 14 may be elevated or lowered to a height above or below a portion of the body 12. The boom 16 has a plurality of telescoping booms that allows the second end 18 and the platform 14 to be moved closer to or away from the first end 17 and the body 12.

As shown in FIG. 1, the body 12 includes a frame 20 coupled to a turntable 22. In some examples, the first end 17 of the boom 16 is coupled to the turntable 22. According to an alternative example, the body 12 does not include a turntable and the boom 16 is coupled directly to the lower frame 20 (e.g., the boom 16 may be provided as part of a telehandler). According to still another alternative example, the boom 16 is incorporated as part of an articulating boom lift (e.g., as the main boom, as the tower boom, as both the main boom and the tower boom, etc.).

As shown in FIG. 1, the boom lift 10 is mobile and the lower frame 20 includes wheels 24, which may be driven using a prime mover and steered to maneuver the boom lift 10. In other examples, the lower frame 20 includes other devices to propel or steer the lift device, such as tracks. In still other examples, the boom lift 10 is a trailer that is towed by another vehicle, and the lower frame 20 may include one or more wheels or elements configured to support the boom lift 10. In still other examples, the boom lift 10 may be a stationary device and the lower frame 20 may lack any wheels or other elements to facilitate the movement of the lift device and may instead include legs or other similar structures.

The turntable 22 is coupled to the lower frame 20 such that the turntable 22 may be rotated relative to the lower frame 20 about a vertical axis of rotation (e.g., by a motor). In some examples, the turntable 22 houses a prime mover that powers one or more of the wheels 24. For example, the turntable 22 may include one or more electric or hydraulic motors to drive the wheels 24. The boom lift 10 may receive power from an external source via a tether (e.g., cable, cord, etc.), may include an on-board generator set to provide electrical power, may include a hydraulic pump coupled to a motor (e.g., electric, internal combustion, etc.), or may include an energy storage device (e.g., batteries).

In some examples, the turntable 22 includes an internal structure configured to support the boom 16. The internal structure may interface with the first end 17 of the boom 16. A lift actuator, shown as hydraulic cylinder 26, is coupled between the turntable 22 and the boom 16. In some examples, the hydraulic cylinder 26 raises or lowers the boom (e.g., to rotate the second end 18 of the boom 16 relative to the turntable 22). As shown in FIG. 1, turntable 22 further includes a hydraulic pump 28 that provides pressurized hydraulic fluid to the hydraulic cylinder 26 and other hydraulic components of the boom lift 10. Turntable 22 may further include a hydraulic fluid reservoir fluidly coupled to the hydraulic pump 28.

The boom 16 is shown as a telescoping boom having a plurality of booms that slide relative to each other along a longitudinal axis 30 to increase or decrease the length of the boom 16 and the distance between the platform 14 and the body 12. As shown in FIG. 1, the boom 16 is a three-piece boom with a first or base boom 32, a second or mid boom 34, and a third or fly boom 36. The base boom 32 is coupled to the turntable 22 and the fly boom 36 is coupled to the platform 14.

In some examples, the boom sections (32, 34, and 36) have tubular, rectangular cross sectional shapes. In other examples, the boom sections (32, 34, and 36) may have other cross-sectional shapes (e.g., square, hexagonal, round, etc.). While the example shown in FIG. 1 has three boom sections, in other examples, the boom 16 may include more or fewer boom sections. For example, the boom 16 may include five boom sections. The boom 16 may further include a linkage, shown as connecting linkage 38, that couples the platform 14 to the fly boom 36. The connecting linkage 38 may be, for example, a rotator or a jib or may include both a rotator and a jib. The connecting linkage 38 may allow the platform 14 to remain level as the boom 16 is raised or lowered and the angle of the boom 16 changes. The connecting linkage 38 may be controlled by a self-leveling system including a hydraulic cylinder configured to operate based on the position of the hydraulic cylinder 26.

Referring still to the example boom lift 10 shown in FIG. 1, the base boom 32, the mid boom 34, and the fly boom 36 move relative to each other along the longitudinal axis 30 as the boom 16 is extended or retracted. With the base boom 32 stationary, the mid boom 34 moves relative to the base boom 32, and the fly boom 36 moves relative to the mid boom 34. The boom lift 10 includes an actuator, shown as cylinder 40, provided within the boom 16 to extend or retract the boom 16. The cylinder 40 may include a rod 42 and a cylinder body 44. As shown in FIG. 1, the distal end 43 of the rod 42 is coupled to the base boom 32 proximate the first end 17 of the boom 16 with a bracket 46. The cylinder 40 extends along the boom 16 and extends through the end of the mid boom 34. The end 45 of the cylinder body 44 is coupled to the mid boom 34 with a bracket 48. The distal end 47 of the cylinder body 44 is coupled to a slide bracket 50, which supports the distal end 47 within the fly boom 36. The slide bracket 50 slidably engages the interior surfaces of the fly boom 36 via slide bearings.

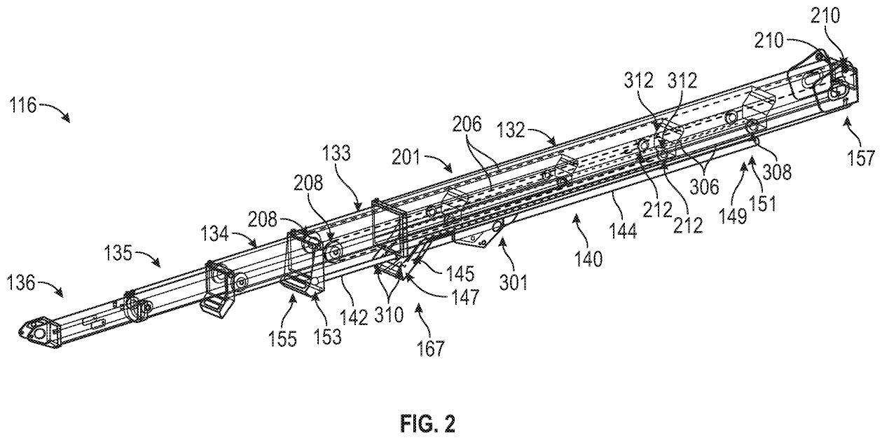

Referring now to FIGS. 2-7, a boom 116 (or boom assembly) is shown according to an exemplary embodiment. The boom 116 may be similar to the boom 16, with several boom sections (five boom sections 132-136, as shown) that slide relative to each other to increase or decrease the length of the boom 116. The boom 116 may be coupled to a lift device similar to the boom lift 10, a telehandler, or in any other equipment described above with respect to the boom 16. The boom 116 shown in FIGS. 2-7 is a telescoping boom with rectangular boom sections that nest into each other to decrease the length of the boom 116. Specifically, the boom 116 includes a first or base boom 132, a second or inner mid boom 133 slidably coupled to an inner cavity of the base boom 132, and a third or middle mid boom 134 slidably coupled to an inner cavity of the inner mid boom 133, a fourth or outer mid boom 135 slidably coupled to an inner cavity of the middle mid boom 134, and a fifth or fly boom 136 slidably coupled to an inner cavity of the outer mid boom 135.

Unlike the boom 16, in which the cylinder 40 is positioned within the inner cavities of the boom sections 32-36, the boom 116 includes a cylinder 140 (e.g., a hydraulic cylinder, a linear actuator, etc.) positioned outside the inner cavities of the boom sections 132-136. As discussed above, this may allow for a reduced overall boom size when the boom is retracted while providing an extended length similar to that of a typical boom with a larger retracted size. The cylinder 140 includes a body or cylinder body 144 and a rod 142. In the embodiment shown, the cylinder body 144 is coupled to the base boom 132. For example, as shown in FIGS. 2-7, a distal end 145 of the cylinder body 144 is coupled to a mounting bracket 147 of the base boom 132, and a proximal end 149 of the cylinder body 144 is coupled to a mounting bracket 151. In some embodiments, the cylinder body 144 may be coupled to the base boom 132 only at the distal end 145 of the cylinder body 144, and the proximal end 149 of the cylinder body 144 may be cantilevered. In some embodiments, the cylinder body 144 may be coupled to the base boom 132 only at the proximal end 149 of the cylinder body 144. A distal end 153 of the rod 142 is coupled to the inner mid boom 133, for example, to a mounting bracket 155 coupled to the inner mid boom 133. Thus, when the cylinder body 144 is pressurized (e.g., by supplying hydraulic fluid to the cylinder body 144) causing the rod 142 to extend outwardly from the cylinder body 144, the inner mid boom 133 is configured to extend outwardly from the base boom 132, extending the length of the boom 116. In some embodiments, the proximal end 149 of the cylinder body 144 may be coupled to the inner mid boom 133, and the distal end of the rod 142 may be coupled to the base boom 132.

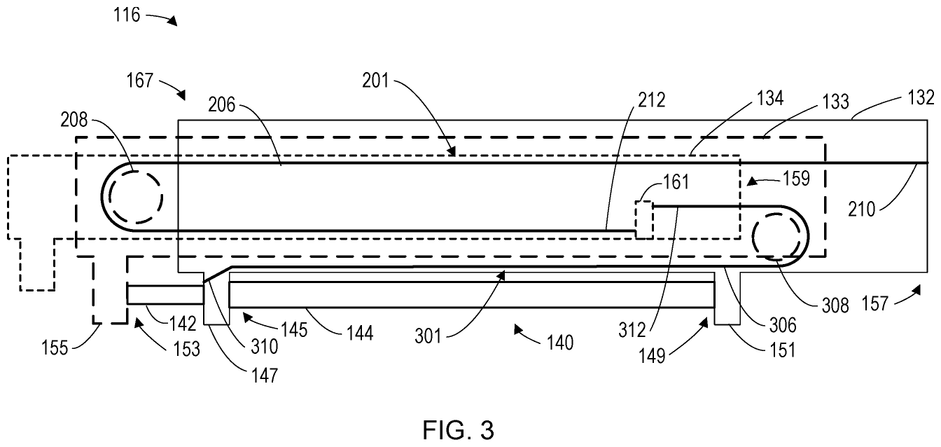

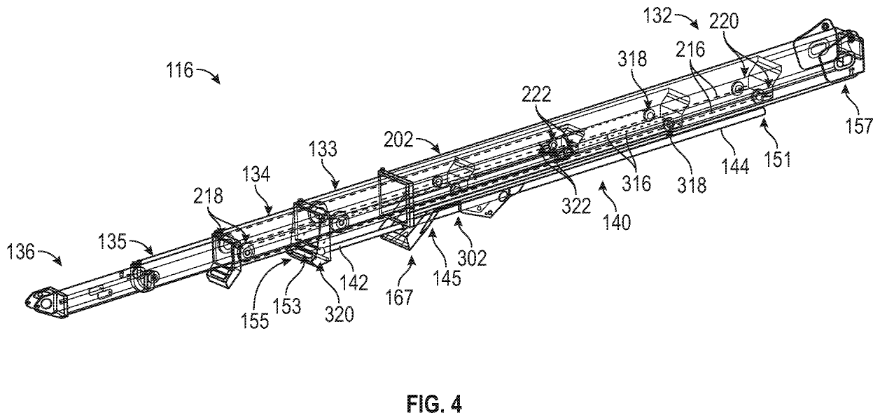

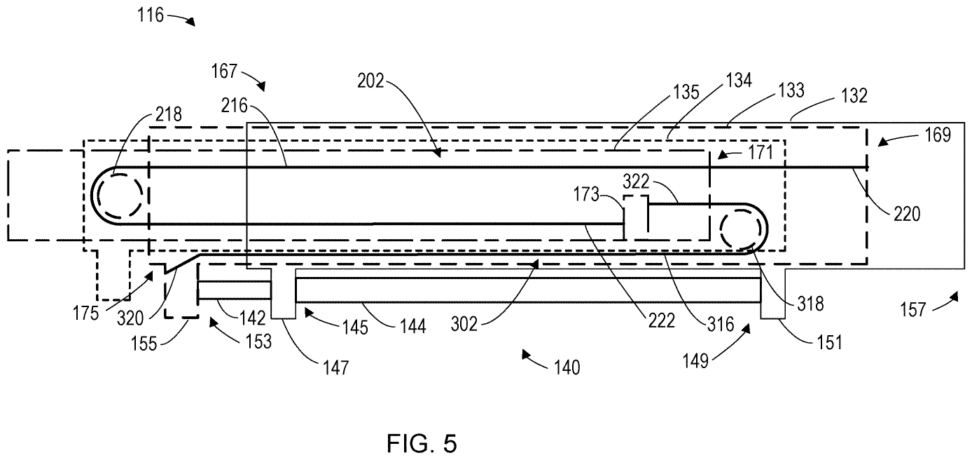

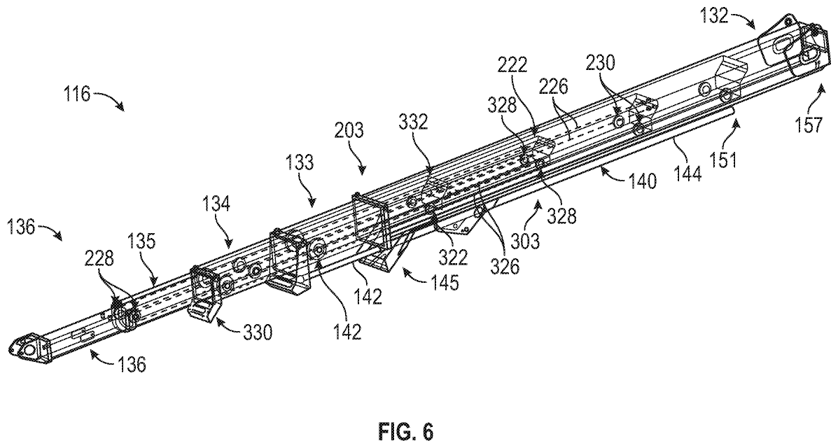

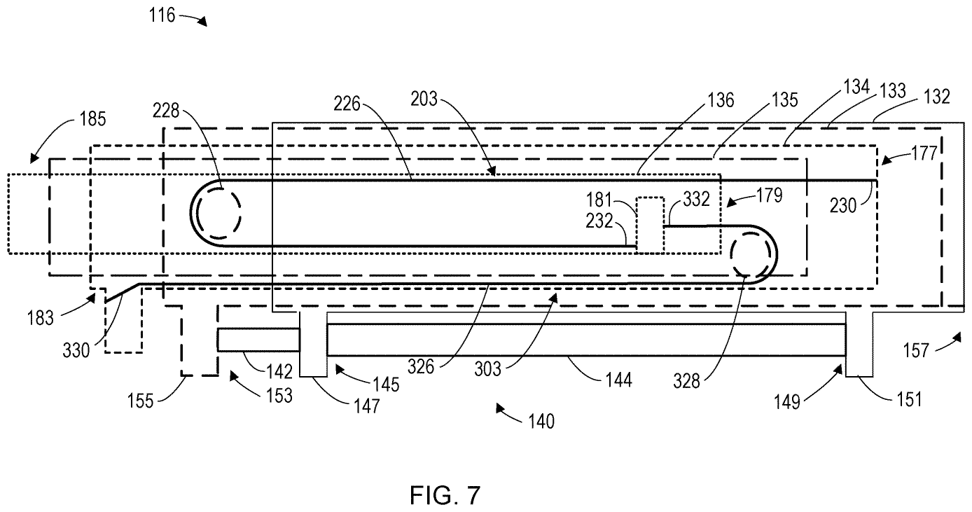

The boom 116 further includes several extension assemblies 201-203 and several retraction assemblies 301-303 configured to control the extension and retraction of the middle mid boom 134, the outer mid boom 135, and the fly boom 136. For example, FIGS. 2 and 3 respectively show a perspective view and a schematic side view of the boom 116 including a first extension assembly 201 and a first retraction assembly 301. For clarity, the other extension assemblies 202, 203 and retraction assemblies 302, 303 are not shown in FIGS. 2 and 3. The second extension assembly 202 and the second retraction assembly 302 are shown in FIGS. 4 and 5, and the third extension assembly 203, and the third retraction assembly 303 are shown in FIGS. 6 and 7. For clarity, the outer mid boom 135 and the fly boom 136 are not shown in FIG. 3, and the fly boom 136 is not shown in FIG. 5.

Referring still to FIGS. 2 and 3, the first extension assembly 201 includes two ropes 206 and two pulleys 208. In some embodiments, the first extension assembly 201 may include more (e.g., three, four, etc.) or fewer (i.e., one) ropes 206 and pulleys 208. The term “rope” as used herein may refer to any tension member, including belts, cables, wires, chains, etc. The term “pulley” as used herein may refer to any rotatable device configured to redirect the force of the rope, including wheels, sheaves, sprockets, etc. Each rope 206 is coupled at a first end 210 to a proximal end 157 of the base boom 132 and at a second end 212 to a proximal end 159 of the middle mid boom 134. The middle mid boom 134 may include a bracket 161 at the proximal end 159 to which the second end 212 can be coupled. Each rope 206 wraps around a pulley 208 coupled to and rotatable relative to the inner mid boom 133. When the cylinder 140 extends (i.e., when the rod 142 extends from the cylinder body 144), causing the inner mid boom 133 to extend relative to the base boom 132 (e.g., to the left as shown in FIGS. 2 and 3), the pulleys 208 cause tension in the ropes 206. With the first end 210 of each rope 206 anchored to the proximal end 157 of the base boom 132, the second end 212 of each rope 206 is pulled in the direction of extension of the inner mid boom 133 (e.g., to the left as shown in FIGS. 2 and 3). This pulls the bracket 161 in the same direction, causing the middle mid boom 134 to extend out of the inner mid boom 133 as the inner mid boom 133 extends out of the base boom 132. Thus, because of the first extension assembly 201, the extension of the rod 142 from the cylinder body 144 causes both the extension of the inner mid boom 133 out of the base boom 132 and the extension of the middle mid boom 134 out of the inner mid boom 133.

Referring still to FIGS. 2 and 3, the first retraction assembly 301 may perform substantially the opposite function of the first extension assembly 201. Specifically, the first retraction assembly 301 may cause the middle mid boom 134 to be retracted into the inner mid boom 133 when the cylinder 140 causes the inner mid boom 133 to be retracted into the base boom 132. The first retraction assembly 301 includes two ropes 306 and two pulleys 308. In some embodiments, the first retraction assembly 301 may include more (e.g., three, four, etc.) or fewer (i.e., one) ropes 306 and pulleys 308. Each rope 306 is coupled at a first end 310 to a distal end 167 of the base boom 132 and at a second end 312 to the proximal end 159 of the middle mid boom 134. In some embodiments, the second end 312 of each rope 306 may be coupled to the bracket 161. In other embodiments, the middle mid boom 134 may include a second bracket to which the second end 312 of each rope 306 may be coupled. When the cylinder 140 retracts (i.e., when the rod 142 retracts into the cylinder body 144), causing the inner mid boom 133 to retract into the base boom 132 (e.g., moving the inner mid boom 133 to the left as shown in FIGS. 2 and 3), the pulleys 308 cause tension in the ropes 306. With the first end 310 of each rope 306 anchored to the distal end 167 of the base boom 132, the second end 312 of each rope 306 is pulled in the direction of retraction of the inner mid boom 133 (e.g., to the left as shown in FIGS. 2 and 3). For example, when the second end 312 of each rope 306 is coupled to the bracket 161, the tension in the ropes 306 pulls the bracket 161 in the same direction, causing the middle mid boom 134 to retract into the inner mid boom 133 as the inner mid boom 133 retracts into the base boom 132.

Referring now to FIGS. 4 and 5, the boom 116 is shown with a second extension assembly 202 and a second retraction assembly 302 shown and the other extension assemblies 201, 203 and retraction assemblies 301, 303 hidden. The second extension assembly 202 and the second retraction assembly 302 are configured to control the extension and retraction of the outer mid boom 135 in substantially the same manner that the first extension assembly 201 and the first retraction assembly 301 are configured to control the extension and retraction of the middle mid boom 134. For example, the second extension assembly 202 includes two ropes 216 and two pulleys 218. In some embodiments, the second extension assembly 202 may include more (e.g., three, four, etc.) or fewer (i.e., one) ropes 216 and pulleys 218. Each rope 216 is coupled at a first end 220 to a proximal end 169 of the inner mid boom 133 and at a second end 222 to a proximal end 171 of the outer mid boom 135. The outer mid boom 135 may include a bracket 173 at the proximal end 171 to which the second end 222 can be coupled. Each rope 216 wraps around a pulley 218 coupled to the middle mid boom 134. When the cylinder 140 extends (i.e., when the rod 142 extends from the cylinder body 144), causing the inner mid boom 133 to extend relative to the base boom 132 (e.g., to the left as shown in FIGS. 2 and 3) and the middle mid boom 134 to extend relative to the inner mid boom 133 (as discussed above with respect to FIGS. 2 and 3), the pulleys 218 cause tension in the ropes 216. With the first end 220 of each rope 216 anchored to the proximal end 169 of the inner mid boom 133, the second end 222 of each rope 216 is pulled in the direction of extension of the middle mid boom 134 (e.g., to the left as shown in FIGS. 4 and 5). This pulls the bracket 173 in the same direction, causing the outer mid boom 135 to extend out of the middle mid boom 134 as the middle mid boom 134 extends out of the inner mid boom 133. Thus, because of the second extension assembly 202 and the first extension assembly 201, the extension of the rod 142 from the cylinder body 144 causes the extension of the inner mid boom 133 out of the base boom 132, the extension of the middle mid boom 134 out of the inner mid boom 133, and the extension of the outer mid boom 135 out of the middle mid boom 134.

The second retraction assembly 302 may perform substantially the opposite function of the second extension assembly 202. Specifically, the second retraction assembly 302 may cause the outer mid boom 135 to be retracted into the middle mid boom 134 when the cylinder 140 causes the inner mid boom 133 to be retracted into the base boom 132 and the middle mid boom 134 to be retracted into the inner mid boom 133. The second retraction assembly 302 includes two ropes 316 and two pulleys 318. In some embodiments, the second retraction assembly 302 may include more (e.g., three, four, etc.) or fewer (i.e., one) ropes 316 and pulleys 318. Each rope 316 is coupled at a first end 320 to a distal end 175 of the inner mid boom 133 and at a second end 322 to the proximal end 171 of the outer mid boom 135. In some embodiments, the second end 322 of each rope 316 may be coupled to the bracket 173. In other embodiments, the outer mid boom 135 may include a second bracket to which the second end 322 of each rope 316 may be coupled. When the cylinder 140 retracts (i.e., when the rod 142 retracts into the cylinder body 144), causing the inner mid boom 133 to retract into the base boom 132 (e.g., moving the inner mid boom 133 to the left as shown in FIGS. 2 and 3) and the middle mid boom 134 to retract into the inner mid boom 133, the pulleys 318 cause tension in the ropes 316. With the first end 320 of each rope 316 anchored to the distal end 175 of the inner mid boom 133, the second end 322 of each rope 316 is pulled in the direction of retraction of the middle mid boom 134 (e.g., to the left as shown in FIGS. 4 and 5). For example, when the second end 322 of each rope 316 is coupled to the bracket 173, the tension in the ropes 316 pulls the bracket 173 in the same direction, causing the outer mid boom 135 to retract into the middle mid boom 134 as the middle mid boom 134 retracts into the inner mid boom 133, and the inner mid boom 133 retracts into the base boom 132.

Referring now to FIGS. 6 and 7, the boom 116 is shown with a third extension assembly 203 and a third retraction assembly 303 shown and the other extension assemblies 201, 202 and retraction assemblies 301, 302 hidden. The third extension assembly 203 and the third retraction assembly 303 are configured to control the extension and retraction of the fly boom 136 in substantially the same manner that the first extension assembly 201 and the first retraction assembly 301 are configured to control the extension and retraction of the middle mid boom 134 and that the second extension assembly 202 and the second retraction assembly 302 are configured to control the extension and retraction of the outer mid boom 135. For example, the third extension assembly 203 includes two ropes 226 and two pulleys 228. In some embodiments, the third extension assembly 203 may include more (e.g., three, four, etc.) or fewer (i.e., one) ropes 226 and pulleys 228. Each rope 226 is coupled at a first end 230 to a proximal end 177 of the middle mid boom 134 and at a second end 232 to a proximal end 179 of the fly boom 136. The fly boom 136 may include a bracket 181 at the proximal end 179 to which the second end 232 can be coupled. Each rope 226 wraps around a pulley 228 coupled to the outer mid boom 135. When the cylinder 140 extends (i.e., when the rod 142 extends from the cylinder body 144), causing the inner mid boom 133 to extend relative to the base boom 132 (e.g., to the left as shown in FIGS. 6 and 7), the middle mid boom 134 to extend relative to the inner mid boom 133 (as discussed above with respect to FIGS. 2 and 3), and the outer mid boom 135 to extend relative to the middle mid boom 134 (as discussed above with respect to FIGS. 4 and 5), the pulleys 228 cause tension in the ropes 226. With the first end 230 of each rope 226 anchored to the proximal end 177 of the middle mid boom 134, the second end 322 of each rope 226 is pulled in the direction of extension of the outer mid boom 135 (e.g., to the left as shown in FIGS. 6 and 7). This pulls the bracket 181 in the same direction, causing the fly boom 136 to extend out of the outer mid boom 135 as the outer mid boom 135 extends out of the middle mid boom 134. Thus, because of the third extension assembly 203, the second extension assembly 202, and the first extension assembly 201, the extension of the rod 142 from the cylinder body 144 causes the extension of the inner mid boom 133 out of the base boom 132, the extension of the middle mid boom 134 out of the inner mid boom 133, the extension of the outer mid boom 135 out of the middle mid boom 134, and the extension of the fly boom 136 out of the outer mid boom 135.

The third retraction assembly 303 may perform substantially the opposite function of the third extension assembly 203. Specifically, the third retraction assembly 303 may cause the fly boom 136 to be retracted into the outer mid boom 135 when the cylinder 140 causes the inner mid boom 133 to be retracted into the base boom 132, the middle mid boom 134 to be retracted into the inner mid boom 133, and the outer mid boom 135 to be retracted into the middle mid boom 134. The third retraction assembly 303 includes two ropes 326 and two pulleys 328. In some embodiments, the third retraction assembly 303 may include more (e.g., three, four, etc.) or fewer (i.e., one) ropes 326 and pulleys 328. Each rope 326 is coupled at a first end 330 to a distal end 183 of the middle mid boom 134 and at a second end 332 to the proximal end 179 of the fly boom 136. In some embodiments, the second end 332 of each rope 326 may be coupled to the bracket 181. In other embodiments, the fly boom 136 may include a second bracket to which the second end 332 of each rope 326 may be coupled. When the cylinder 140 retracts (i.e., when the rod 142 retracts into the cylinder body 144), causing the inner mid boom 133 to retract into the base boom 132 (e.g., moving the inner mid boom 133 to the left as shown in FIGS. 2 and 3), the middle mid boom 134 to retract into the inner mid boom 133, and the outer mid boom 135 to retract into the middle mid boom 134, the pulleys 328 cause tension in the ropes 326. With the first end 330 of each rope 326 anchored to the distal end 183 of the middle mid boom 134, the second end 332 of each rope 326 is pulled in the direction of retraction of the outer mid boom 135 (e.g., to the left as shown in FIGS. 6 and 7). For example, when the second end 332 of each rope 326 is coupled to the bracket 181, the tension in the ropes 326 pulls the bracket 181 in the same direction, causing the fly boom 136 to retract into the outer mid boom 135 as the outer mid boom 135 retracts into the middle mid boom 134, the middle mid boom 134 retracts into the inner mid boom 133, and the inner mid boom 133 retracts into the base boom 132.

As discussed above, it should be understood that in some embodiments the boom 116 may include more or fewer boom sections than as shown in FIGS. 2-7. For example, in some embodiments, the boom 116 may include only three boom sections (e.g., similar to the boom 116 as shown in FIG. 3). In such an embodiment, the boom 116 may include only one extension assembly (e.g., first extension assembly 201 as shown in FIG. 3) and only one retraction assembly (e.g., first retraction assembly 301 as shown in FIG. 3). As another example, the boom 116 may include six boom sections and may include a fourth extension assembly similar to the three extension assemblies 201-203 and a fourth retraction assembly similar to the three retraction assemblies 301-303.

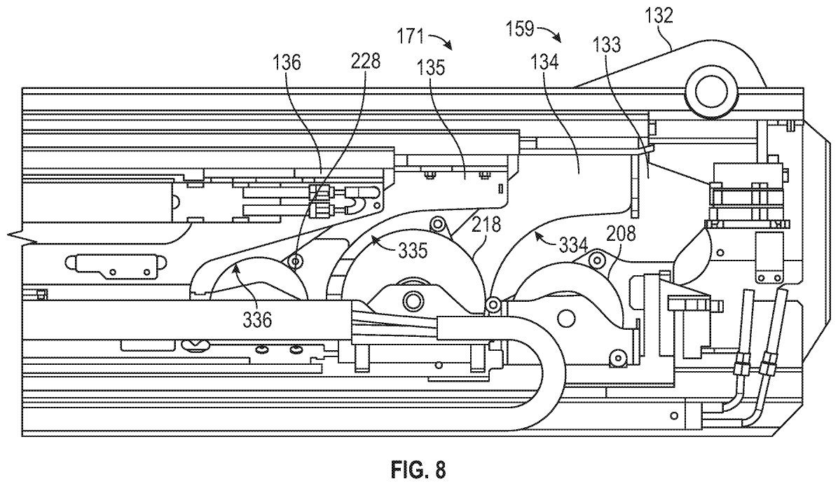

Referring now to FIG. 8, a cross-section of a proximal end of the boom 116 is shown according to an exemplary embodiment. As shown in FIG. 8, the proximal end 159 of the middle mid boom 134 includes a cutout 334 shaped so as not to interfere with the pulleys 208 coupled to the inner mid boom 133, the proximal end 171 of the outer mid boom 135 includes a cutout 335 so as not to interfere with the pulleys 218 coupled to the middle mid boom 134, and the fly boom 136 includes a cutout 336 so as not to interfere with the pulleys 228 coupled to the outer mid boom 135. Stated another way, the cutout 334 may be shaped such that the pulleys 208 may be positioned within the cutout 334 when the inner mid boom 133 and the middle mid boom 134 are fully retracted; the cutout 335 may be shaped such that the pulleys 218 may be positioned within the cutout 335 when the inner mid boom 133, the middle mid boom 134, and the outer mid boom 135 are fully retracted; and the cutout 336 may be shaped such that the pulleys 228 may be positioned within the cutout 336 when the inner mid boom 133, the middle mid boom 134, the outer mid boom 135, and the fly boom 136 are fully retracted. The upper portion of the proximal end of each of the inner mid boom 133, the middle mid boom 134, and the outer mid boom 135 may extend proximal to a proximal end of the respective pulley 208, 218, 228, while the lower portion of the proximal end of each of the inner mid boom 133, the middle mid boom 134, and the outer mid boom 135 may not extend proximal to a distal end of the respective pulley 208, 218, 228 Because the force on the distal end of the boom 116 is typically downward, the force of the upper portions of the proximal ends 159, 171, 179 of the middle mid boom 134, the outer mid boom 135, and the fly boom 136 against the inner mid boom 133, the middle mid boom 134, and the outer mid boom 135, respectively, reacts the downward force on the distal end of the boom 116. Thus, the cutouts 334, 335, 336 at the lower portions of the proximal ends 159, 171, 179 of the middle mid boom 134, outer mid boom 135, and the fly boom 136 may not substantially affect the lifting capacity of the boom 116.

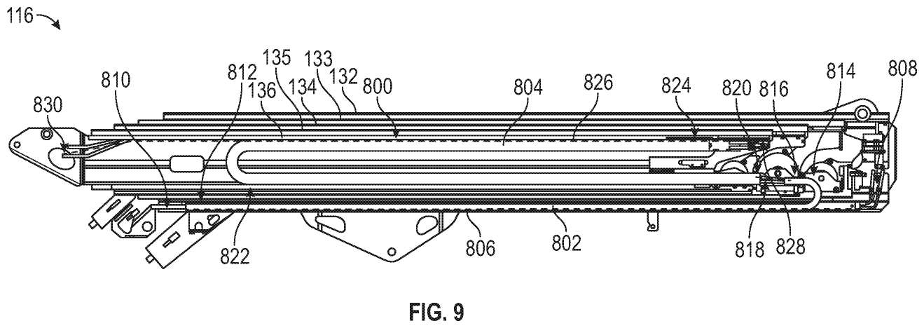

Referring now to FIG. 9, a cross-section of the boom 116 is shown, illustrating a power track assembly 800 according to an exemplary embodiment. As discussed above with respect to the boom 16 in FIG. 1, the boom 116 may similarly be a component of a boom lift with a platform (e.g., platform 14) equipped with tools for use by a worker, including pneumatic tools (e.g., impact wrench, airbrush, nail gun, ratchet, etc.), welders, plasma cutters, and spotlights, among other alternatives, or may be a component of another machine with an implement coupled to the boom 116 (e.g., a saw, drill, jackhammer, lift forks, etc.) in place of or in addition to a platform. The power track assembly 800 may be configured to supply power, pneumatic pressure, hydraulic pressure, and/or other fluids to the distal end 185 of the fly boom 136 from the proximal end 157 of the base boom 132, for example, using hoses, wires, cables, etc.

The power track assembly 800 includes a first power track 802 and a second power track 804. The power tracks 802, 804 (cable tracks, cable carriers, hose carriers drag chains etc.) are flexible, hollow structures that guide and protect cables and hoses on moving machinery, preventing tangling and reducing damage and wear. The power tracks 802, 804 may include a chain of hinged segments that constrain the motion of the hoses and cables in a predictable pattern when the boom 116 is extended or retracted. The power track assembly 800 includes a first hose section 806 within the base boom 132, outside of the power tracks 802, 804, that extends from a first end 808 at the proximal end 157 of the base boom 132 to a second end 810 at the distal end 167 of the base boom 132. The first hose section 806 may include at least a portion of one or more hoses and/or cables. The first hose section 806 may be positioned outside of any power track because the first end 808 and the second end 810 do not move relative to each other as the boom 116 extends.

The second end 810 of the first hose section 806 enters a first end 812 of the power track 802. The first end 812 of the first power track 802 is fixedly coupled to the base boom 132 between the base boom 132 and the inner mid boom 133. The first power track 802 runs along the space between the base boom 132 and the inner mid boom 133 toward the proximal end 157 of the base boom 132. The power track 802 includes a curved portion 814 that curves around the proximal end 169 of the inner mid boom 133 to a second end 816 of the first power track 802. The second end 816 of the power track 802 is fixedly coupled to the proximal end 159 of the middle mid boom 134. As the inner mid boom 133 and middle mid boom 134 extend from the base boom 132, pulling the second end 816 of the first power track 802, the curved portion 814 of the first power track 802 may move in the direction of extension of the inner mid boom 133 (e.g., to the left as shown in FIG. 8), and more of the first power track 802 may move from the space between the base boom 132 and the inner mid boom 133 into the inner cavity of the inner mid boom 133.

The power track assembly 800 includes a second hose section 818 that exits the second end 816 of the first power track 802 and enters a first end 820 of the second power track 804. Like the first hose section 806, the second hose section 818 may be positioned outside of any power track because the ends of the second hose section 818 do not move relative to each other as the boom 116 extends. The first end 820 of the second power track 804 is fixedly coupled to the proximal end 159 of the middle mid boom 134. When the boom 116 is retracted, the second power track 804 extends into an inner cavity of the fly boom 136 and runs along the bottom (as shown in FIG. 8) of the inner cavity of the fly boom 136 to a curved portion 822. At the curved portion 822, the second power track 804 changes direction and runs back toward the first end of the second power track 804 along the top (as shown) of the inner cavity of the fly boom 136. A second end 824 of the second power track 804 is fixedly coupled to the proximal end 179 of the fly boom 136. As the outer mid boom 135 and the fly boom 136 extend from the base boom 132, pulling the second end 824 of the second power track 804, the curved portion 822 of the second power track 804 may move in the opposite direction of the direction of extension of the fly boom 136 (e.g., to the right as shown in FIG. 8) relative to the fly boom 136. At least a portion of the section of the second power track 804 that runs along the bottom of the inner cavity of the fly boom 136 may move into inner cavities of the outer mid boom 135 and the middle mid boom 134. A portion of the second power track 804 that runs along the top of the inner cavity of the fly boom 136 may move to the bottom of the inner cavity of the fly boom 136 and, as the extension of the boom 116 continues, into the inner cavities of the outer mid boom 135 and the middle mid boom 134.

The power track assembly 800 includes a third hose section 826 extending from a first end 828 that exits the second end 824 of the second power track 804 to a second end 830 at the distal end 185 of the fly boom 136. Like the first hose section 806, the third hose section 826 may be positioned outside of any power track because the first end 828 and the second end 830 of the third hose section 826 do not move relative to each other as the boom 116 extends. In some examples, the hoses and/or cables may be contiguous from the first end 808 of the first hose section 806 to the second end 830 of the third hose section 826. In other embodiments, the hoses and/or cable may include breaks and connectors (e.g., separate segments of hose or cable coupled by a connector, coupling, or fitting). For example, breaks and connectors may be located at interfaces between the exposed first, second, and third hose sections 806, 818, 826 (i.e., the hose section not inside a power track 802, 804) and the power tracks 802, 804. Breaks and connectors may allow for ease of assembly and maintenance. Thus, it should be understood that “hose section” as used herein may refer to a portion or segment of a hose or may refer to an entire hose. For example, a single hose may include multiple hose sections, or multiple separate hoses may be referred to as hose sections and may be coupled together, for example, by connectors, couplings, or fittings, as discussed above.

The second end 830 of the third hose section 826 may be connected to a tool or implement at the distal end 185 of the fly boom 136 (e.g., on a work platform coupled to the distal end 185 of the fly boom 136). For example, a hydraulic hose may be connected to a hydraulic pump in the base of a lift device (e.g., the hydraulic pump 28 of the boom lift 10 where the boom 116 is used in place of the boom 16) and may run through the power track assembly 800 to the second end 830 of the third hose section 826 to be connected to a hydraulic tool at the platform (e.g., the platform 14 of the boom lift 10).

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations are illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

What is claimed is:

1. A boom assembly for a lift device, the boom assembly comprising:
a first boom section, a second boom section slidably coupled to a first inner cavity of the first boom section, and a third boom section slidably coupled to a second inner cavity of the second boom section;
a linear actuator comprising a body and a rod, the linear actuator positioned outside of the first inner cavity and the second inner cavity and coupled to the first boom section and the second boom section such that extension of the rod relative to the body is configured to cause the second boom section to extend from the first boom section, and retraction of the rod relative to the body is configured to cause the second boom section to retract into the first boom section; and
a first extension assembly comprising a first pulley coupled to the second boom section and a first rope coupled to the first boom section, wrapping around the first pulley, and coupled to the third boom section, wherein the extension of the second boom section from the first boom section is configured to tension the first rope to cause the third boom section to extend from the second boom section.

2. The boom assembly of claim 1, wherein the first pulley is coupled to a distal end of the second boom section, and the first rope is coupled to a proximal end of the first boom section and a proximal end of the third boom section.

3. The boom assembly of claim 1, further comprising a first retraction assembly comprising a second pulley coupled to the second boom section and a second rope coupled to the first boom section, wrapping around the second pulley, and coupled to the third boom section, wherein the retraction of the second boom section into the first boom section is configured to tension the second rope to cause the third boom section to retract into the second boom section.

4. The boom assembly of claim 3, wherein the second pulley is coupled to a proximal end of the second boom section, and the second rope is coupled to a distal end of the first boom section and a proximal end of the third boom section.

5. The boom assembly of claim 1, wherein a proximal end of the third boom section includes a cutout such that when the third boom section and the second boom section are fully retracted, the first pulley is positioned within the cutout.

6. The boom assembly of claim 5, wherein when the third boom section and the second boom section are fully retracted, an upper portion of the proximal end of the third boom section extends proximal to a proximal end of the first pulley, and a lower portion of the proximal end of the third boom section does not extend proximal to a distal end of the first pulley.

7. A boom assembly for a lift device, the boom assembly comprising:
a base boom, an inner mid boom slidably coupled to a first inner cavity of the base boom, a middle mid boom slidably coupled to a second inner cavity of the inner mid boom, an outer mid boom slidably coupled to a third inner cavity of the middle mid boom, and a fly boom slidably coupled to a fourth inner cavity of the outer mid boom;
a linear actuator positioned outside of all of the first inner cavity, the second inner cavity, and the third inner cavity and comprising a body and a rod, the linear actuator coupled to the base boom and the inner mid boom such that is extension of the rod relative to the body configured to cause the inner mid boom to extend from the base boom, and retraction of the rod relative to the body is configured to cause the inner mid boom to retract into the base boom;
a first extension assembly comprising a first pulley coupled to the inner mid boom and a first rope coupled to the base boom, wrapping around the first pulley, and coupled to the middle mid boom, wherein the extension of the inner mid boom from the base boom is configured to tension the first rope to cause the middle mid boom to extend from the inner mid boom; and
a first retraction assembly comprising a second pulley coupled to the inner mid boom and a second rope coupled to the base boom, wrapping around the second pulley, and coupled to the middle mid boom, wherein the retraction of the inner mid boom into the base boom is configured to tension the second rope to cause the middle mid boom to retract into the inner mid boom.

8. The boom assembly of claim 7, further comprising:
a second extension assembly comprising a third pulley coupled to the middle mid boom and a third rope coupled to the inner mid boom, wrapping around the third pulley, and coupled to the outer mid boom, wherein the extension of the middle mid boom from the inner mid boom is configured to tension the third rope to cause the outer mid boom to extend from the middle mid boom; and
a second retraction assembly comprising a fourth pulley coupled to the middle mid boom and a fourth rope coupled to the inner mid boom, wrapping around the fourth pulley, and coupled to the outer mid boom, wherein the retraction of the middle mid boom into the inner mid boom is configured to tension the fourth rope to cause the outer mid boom to retract into the middle mid boom.

9. The boom assembly of claim 8, further comprising:
a third extension assembly comprising a fifth pulley coupled to the outer mid boom and a fifth rope coupled to the middle mid boom, wrapping around the fifth pulley, and coupled to the fly boom, wherein the extension of the outer mid boom from the middle mid boom is configured to tension the fifth rope to cause the fly boom to extend from the outer mid boom; and
a third retraction assembly comprising a sixth pulley coupled to the outer mid boom and a sixth rope coupled to the middle mid boom, wrapping around the sixth pulley, and coupled to the fly boom, wherein the retraction of the outer mid boom into the middle mid boom is configured to tension the sixth rope to cause the fly boom to retract into the outer mid boom.

10. The boom assembly of claim 7, further comprising a power track assembly comprising:
a first power track positioned in the first inner cavity and coupled to a distal end of the base boom and a proximal end of the middle mid boom; and
a second power track positioned in a fifth inner cavity of the fly boom and coupled to the proximal end of the middle mid boom and a proximal end of the fly boom.

11. The boom assembly of claim 10, wherein the first power track includes a first curved portion that curves around the proximal end of the inner mid boom when the boom assembly is in a retracted position.

12. The boom assembly of claim 11, wherein the second power track extends in a distal direction of the boom assembly from a first end to a second curved portion and back in a proximal direction of the boom assembly from the second curved portion to a second end.

13. The boom assembly of claim 10, further comprising a first hose section extending through the first power track and the second power track.

14. The boom assembly of claim 13, further comprising a second hose section extending from a proximal end of the base boom to a first end of the first hose section and a third hose section extending from a second end of the first hose section to a distal end of the fly boom.

15. The boom assembly of claim 7, wherein a proximal end of the middle mid boom includes a cutout such that when the boom assembly is fully retracted, the first pulley is positioned within the cutout.

16. The boom assembly of claim 15, wherein when the boom assembly is fully retracted, an upper portion of the proximal end of the middle mid boom extends proximal to a proximal end of the first pulley, and a lower portion of the proximal end of the middle mid boom does not extend proximal to a distal end of the first pulley.

17. The boom assembly of claim 7, further comprising:
a second extension assembly comprising a third pulley coupled to the middle mid boom and a third rope coupled to the inner mid boom, wrapping around the third pulley, and coupled to the outer mid boom, wherein the extension of the middle mid boom from the inner mid boom is configured to tension the third rope to cause the outer mid boom to extend from the middle mid boom; and
a third extension assembly comprising a fifth pulley coupled to the outer mid boom and a fifth rope coupled to the middle mid boom, wrapping around the fifth pulley, and coupled to the fly boom, wherein the extension of the outer mid boom from the middle mid boom is configured to tension the fifth rope to cause the fly boom to extend from the outer mid boom; wherein:
a proximal end of the middle mid boom includes a first cutout such that when the boom assembly is fully retracted, the first pulley is positioned within the first cutout;
a proximal end of the outer mid boom includes a second cutout such that when the boom assembly is fully retracted, the second pulley is positioned within the second cutout; and
a proximal end of the fly boom includes a third cutout such that when the boom assembly is fully retracted, the third pulley is positioned within the third cutout.

18. The boom assembly of claim 17, wherein when the boom assembly is fully retracted:
an upper portion of the proximal end of the middle mid boom extends proximal to a proximal end of the first pulley, and a lower portion of the proximal end of the middle mid boom does not extend proximal to a distal end of the first pulley;
an upper portion of the proximal end of the outer mid boom extends proximal to a proximal end of the second pulley, and a lower portion of the proximal end of the outer mid boom does not extend proximal to a distal end of the second pulley; and
an upper portion of the proximal end of the fly boom extends proximal to a proximal end of the third pulley, and a lower portion of the proximal end of the fly boom does not extend proximal to a distal end of the third pulley.

19. A boom assembly for a lift device, the boom assembly comprising:
a base boom, an inner mid boom slidably coupled to a first inner cavity of the base boom, a middle mid boom slidably coupled to a second inner cavity of the inner mid boom, an outer mid boom slidably coupled to a third inner cavity of the middle mid boom, and a fly boom slidably coupled to a fourth inner cavity of the outer mid boom;
a linear actuator positioned outside of all of the first inner cavity, the second inner cavity, and the third inner cavity and comprising a body and a rod, the linear actuator coupled to the base boom and the inner mid boom such that extension of the rod relative to the body configured to cause the inner mid boom to extend from the base boom, and retraction of the rod relative to the body is configured to cause the inner mid boom to retract into the base boom; and
a plurality of extension assemblies each comprising a rope and a pulley, the plurality of extension assemblies configured to cause the middle mid boom to extend from the second inner cavity, the outer mid boom to extend from the third inner cavity, and the fly boom to extend from the fourth inner cavity upon extension of the inner mid boom from the base boom.

20. The boom assembly of claim 19, further comprising a plurality of retraction assemblies each comprising a rope and a pulley, the plurality of extension assemblies configured to cause the middle mid boom to retract into the second inner cavity, the outer mid boom to retract into the third inner cavity, and the fly boom to retract into the fourth inner cavity upon retraction of the inner mid boom into the base boom.
